(19) United States
(12) Patent Application Publication
(10) Pub. No.: US 2006/0146531 A1
(43) Pub. Date: Jul. 6, 2006

(54) Linear lighting apparatus with improved heat dissipation

(76) Inventors: Ann Reo, Wilmette, IL (US); Graeme Watt, Altrincham (GB)

Correspondence Address: MCANDREWS HELD & MALLOY, LTD, 500 WEST MADISON STREET, SUITE 3400, CHICAGO, IL, 60661, US

(21) Appl. No.: 11/026,816

(22) Filed: Dec. 30, 2004

(51) Int. Cl. F21V 5/00; F21S 4/00

(52) U.S. Cl. 362/244; 362/249; 362/373

(57) ABSTRACT

The present invention provides a linear lighting apparatus with improved heat dissipation and a method for improving the heat dissipation in a linear lighting apparatus. The apparatus includes a plurality of light emitting diodes, a plurality of primary optical assemblies and an apparatus housing. The primary optical assemblies are each in contact with one of the plurality of light emitting diodes. The primary optical assemblies and a second optical assembly are configured to refract the light so as to create a linear light source emanating from the apparatus. The apparatus housing is configured to dissipate thermal energy from the light emitting diodes.

### BACKGROUND OF THE INVENTION

The present invention generally relates to linear lighting apparatuses. More specifically, the present invention describes an apparatus and method for increased lighting efficiency in a linear lighting apparatus with a plurality of optical assemblies.

Many linear lighting apparatuses exist in the lighting industry today. Several of these apparatuses use light-emitting diodes (“LEDs”) as light sources. LEDs are individual point light sources that each delivers a singular beam of light. When organized in a linear array, the individual beam patterns from each LED are very apparent, resulting in a “scalloping” effect. Eliminating this effect when grazing building facades or glass, for example, is highly desirable. Currently, the only light source that can deliver this continuous, uninterrupted beam of light is fluorescent light sources. However, LEDs are preferred as light sources over fluorescent lights as LEDs can produce a more concentrated beam of light at nadir while consuming less energy than fluorescent lights.

Current linear lighting apparatuses attempt to remedy the scalloping effect of LEDs light sources. However, these lighting apparatuses typically use very inefficient materials and designs for transmitting the light produced by the LEDs. For example, many of the current lighting apparatuses use reflective materials or a singular refractive material in order to direct the LED light from the apparatus.

The use of a reflective material is a very inefficient manner in which to harness and direct light emitted by LEDs. Specifically, the use of reflective materials is very difficult to control the direction of emitted light in very tight spaces. In addition, reflective materials lose a considerable amount of light emitted from the LEDs in trying to reflect the light in a given direction.

The use of refractory materials does provide a higher lighting efficiency than the use of reflective materials, but is far from optimized in current apparatuses and methods. Specifically, current lighting apparatuses employing a refractive material use a singular refractive optical assembly to direct light emitted by LEDs. The use of a singular refractive assembly does not optimize the amount of light harnessed by the assembly and emitted by the apparatus. For example, a substantial portion of light emitted by an LED may not enter into and be refracted by the single optical assembly. The light that does not enter into the optical assembly is therefore lost.

In addition, current linear lighting apparatuses provide a physical gap between an LED and a refractive optical assembly to allow for dissipation of the heat generated by the LED. However, this physical gap allows for a considerable amount of light emitted by the LED avoid being refracted by the optical assembly. Therefore, current linear lighting apparatuses are inefficient in their transmission of light from a light source to the atmosphere around the lighting apparatus.

Increased lighting efficiency is desired for linear lighting apparatuses due to their use in both indoor and outdoor applications. For example, current linear lighting apparatuses may be used to light a billboard or a facade of a building. Such an outdoor application requires considerable luminous flux from a lighting apparatus. In order to increase the amount of light (or luminous flux) output by an apparatus, the number of LEDs in the apparatus or the light-transmission efficiency of the apparatus must be increased. However, as described above, each LED produces a considerable amount of heat. Increasing the number of LEDs in an apparatus only adds to the amount of heat present in the apparatus. This increased heat can drastically shorten the lifespan of the lighting apparatus. Current linear lighting apparatuses do not efficiently dissipate heat from the LEDs.

In addition, increased lighting efficiency is desired for linear lighting apparatuses due to their use in tight, or small architectural details. For example, many linear lighting apparatuses are placed along a narrow opening along a building facade. Due to space constraints, the lighting apparatuses must be small in size, or profile. However, as described above, the luminous flux output of the apparatuses must be considerable. Therefore, a need exists for a linear lighting apparatus that can fit in small locations and still produce considerable luminous flux. In order to meet this need the light efficiency of the linear lighting apparatus must be increased.

Therefore, a need exists to increase the light-transmission efficiency of a linear lighting apparatus without increasing the amount of heat generated. Such an apparatus preferably would provide for a significant increase in the light-transmission efficiency of a linear lighting apparatus without adding to the number of LEDs used to produce a given amount of light. By increasing the light-transmission efficiency of a linear lighting apparatus without adding to the number of LEDs, an improved linear lighting apparatus may produce an equivalent or greater amount of light as current linear lighting apparatuses without producing additional heat.

### BRIEF SUMMARY OF THE INVENTION

The present invention provides a linear lighting apparatus with improved heat dissipation. The apparatus includes a plurality of light emitting diodes, a plurality of primary optical assemblies and an apparatus housing. The plurality of light emitting diodes is capable of emitting light. The primary optical assemblies are each in contact with one of the plurality of light emitting diodes. The primary optical assemblies are configured to refract the light towards a second optical assembly. The second optical assembly is configured to refract the light so as to create a linear light source emanating from the apparatus. The apparatus housing holds the secondary optical assembly and is configured to dissipate radiated energy from the light emitting diodes.

The present invention also provides for a method for improving the heat dissipation in a linear lighting apparatus. The method includes emitting light from a plurality of light emitting diodes, contacting a plurality of primary optical assemblies with the light emitting diodes, refracting the light in each of the primary optical assemblies towards a secondary optical assembly, refracting the light in a secondary optical assembly so that the light is directed in at least one of a desired direction and a desired distribution, and dissipating thermal energy generated by the light emitting diodes.

The present invention also provides for a lighting apparatus with increased heat dissipation capabilities. The apparatus includes a thermally conductive housing, a thermally conductive tray mounted in the housing, and a plurality of light sources attached to the tray. The light sources produce thermal energy that is transferred from the light sources to the tray and from the tray to the housing.

### BRIEF DESCRIPTION OF SEVERAL VIEWS OF THE DRAWINGS

FIG. 1 illustrates a perspective view of a linear lighting apparatus in accordance with an embodiment of the present invention.

FIG. 2 illustrates an exploded perspective view of an LED tray in accordance with an embodiment of the present invention.

FIG. 3 illustrates a tray assembly that includes the LED tray with each of the assembly trays and primary optical assemblies mounted thereon in accordance with an embodiment of the present invention.

FIG. 4 illustrates a perspective view of the tray assembly and housing prior to the insertion of the tray assembly in housing in accordance with an embodiment of the present invention.

FIG. 5 illustrates a perspective view of the housing with the tray assembly inserted into the interior of the housing in accordance with an embodiment of the present invention.

FIG. 6 illustrates a perspective view of the housing with a secondary optical assembly prior to attaching the secondary optical assembly to the housing in accordance with an embodiment of the present invention.

FIG. 7 illustrates a perspective view of the linear lighting apparatus with the secondary optical assembly attached to the housing in accordance with an embodiment of the present invention.

FIG. 8 illustrates several exemplary photometric graphs providing average luminance at various viewing directions for the linear lighting apparatus according to an embodiment of the present invention.

FIG. 9 illustrates a flowchart for a method of configuring a linear LED lighting apparatus to produce a continuous linear beam of light in accordance with an embodiment of the present invention.

FIG. 10 illustrates a flowchart for a method of producing a continuous linear beam of light from a plurality of point sources of light in accordance with an embodiment of the present invention.

FIG. 11 illustrates a flowchart for a method of improving the dissipation of heat generated by a plurality of LEDs in a linear lighting apparatus in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

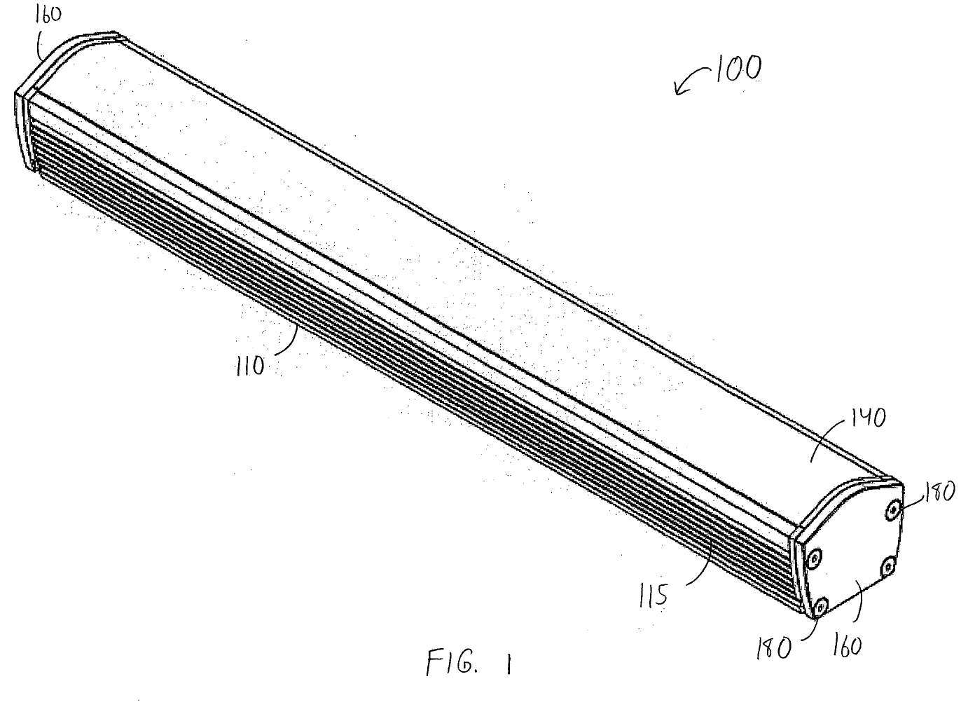

FIG. 1 illustrates a perspective view of a linear lighting apparatus 100 in accordance with an embodiment of the present invention. Linear lighting apparatus 100 may be used as a low voltage linear accent luminaire. Apparatus 100 may be used in both indoor and outdoor applications. In addition, apparatus 100 may be customizable in length. For example, based on at least the selected lengths of some of the various components of apparatus 100, the length of apparatus 100 may be any nominal length up to 108″, for example. However, other lengths are possible and within the scope of the present invention.

Apparatus 100 is capable of and configured to refract light produced from a plurality of LEDs in such a way as to produce a linear beam of light. In other words, LEDs normally produce singular points of light. However, apparatus 100 refracts the light produced by the LEDs so that apparatus 100 produces a continuous linear beam of light emanating along a length of apparatus 100. Such a beam of light is useful, for example, in building grazing applications or wall washing lighting effects.

Apparatus 100 includes a housing 110, a secondary optical assembly 140, two endcaps 160, and several screws 180. As described in more detail below, apparatus 100 produces a continuous linear beam of light emanating from a surface of secondary optical assembly 140 shown in FIG. 1. Apparatus 100 may be powered by an external power source (not shown). Housing 110 can include a plurality of ribs 115. As explained in more detail below, housing 110 acts as a heat sink by dissipating heat generated by LEDs in apparatus 100. In order to increase the capacity of housing 110 to dissipate heat, ribs 115 on the exterior of housing 110 can cause the total surface area of housing 110 to increase. As the surface area of housing 110 increases, the capacity of housing 110 to dissipate heat increases.

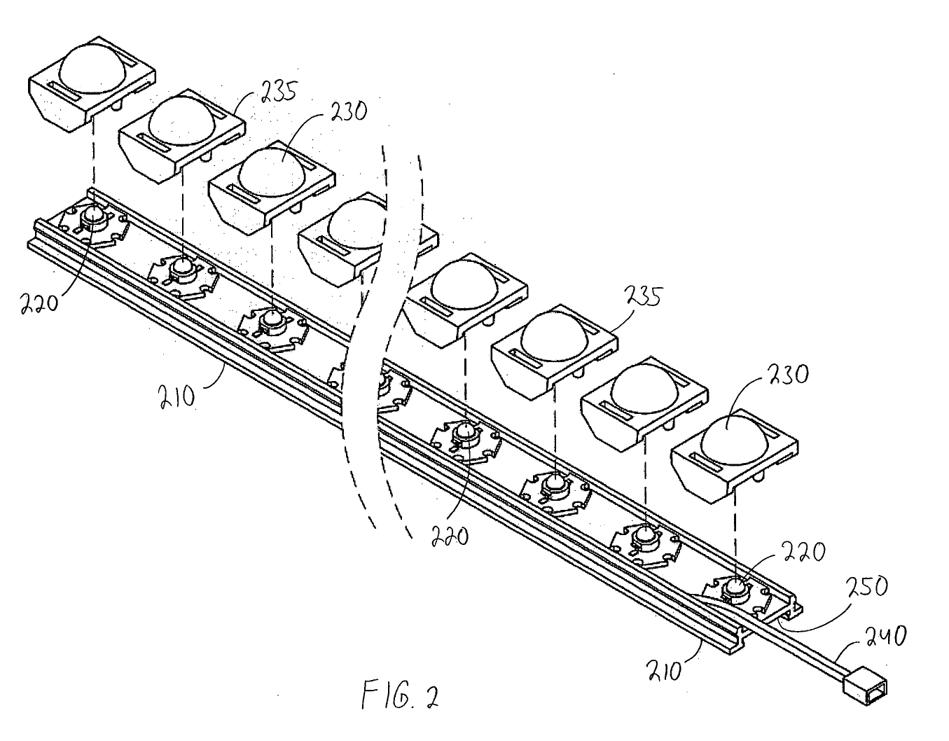

FIG. 2 illustrates an exploded perspective view of an LED tray 210 in accordance with an embodiment of the present invention. LED tray 210 is a component of apparatus 100 that holds a plurality of LEDs 220. LEDs 220 may be mounted on a printed circuit board (“PCB”) (not shown). LED tray 210 includes a rail receptacle 250. Rail receptacle 250 is used to mount tray 210 inside housing 110 (as described below). LEDs 220 are mounted on tray 210. Each of LEDs 220 is electrically connected to a power feed wire 240. Power feed wire 240 can be connected to a power source (not shown) to provide power to LEDs 220.

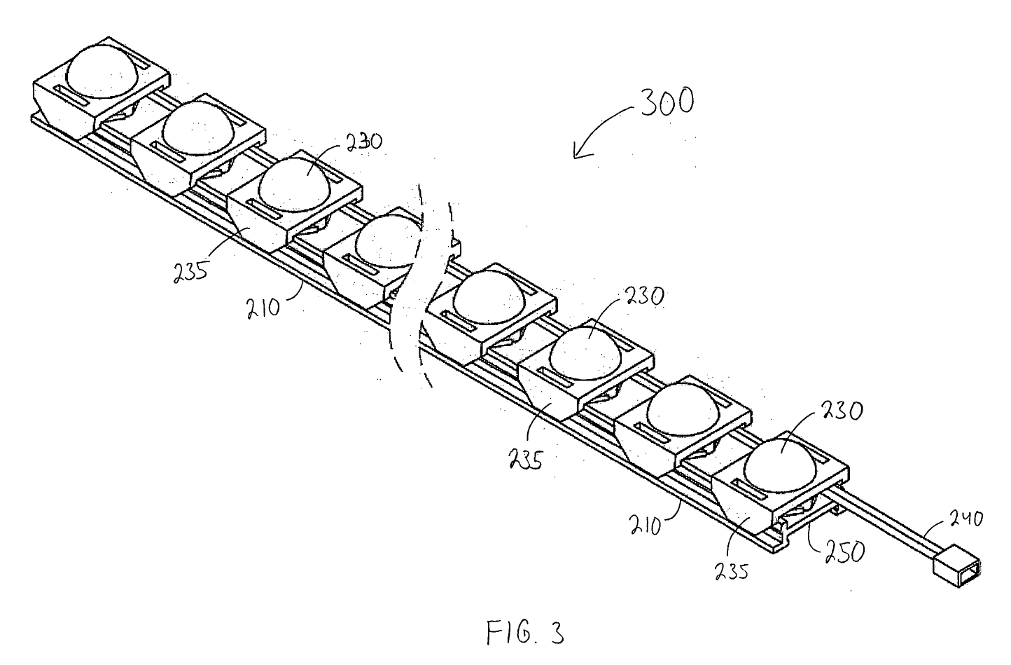

A plurality of primary optical assemblies 230 and assembly trays 235 can be mounted on tray 210 so as to cover each of LEDs 220. FIG. 3 illustrates a tray assembly 300 that includes LED tray 210 with each of assembly trays 235 and primary optical assemblies 230 mounted thereon in accordance with an embodiment of the present invention. Each assembly tray 235 is mounted on tray 210 so that each primary optical assembly 230 physically contacts a corresponding LED 220. Primary optical assemblies 230 may be configured so as to not be attached to either LEDs 220 or the PCB of any LED 220. For example, primary optical assemblies 230 physically contact LEDs 220 without any bonding or attachment between assemblies 230 and LEDs 220 or PCBs.

In another embodiment of the present invention, primary optical assemblies 230 may be an integral part of LEDs 220. For example, an LED 220 may itself comprise a primary optical assembly 230 as part of the LED 220. In other words, a primary optical assembly 230 is not mounted or attached to an LED 220 but instead forms a part of the whole LED 220.

An assembly tray 230 may be bonded to a primary optical assembly 230 by any manner known to one of ordinary skill in the art. In addition, each assembly tray 230 may be mounted on LED tray 210 in any manner known to those of ordinary skill in the art. For example, each assembly tray 235 may include a “snap-fit” connection to rails of LED tray 210. In another example, each assembly 235 may be slid onto rails of LED tray 210 on one end of tray 210 and slid to cover an LED 220. However, any manner of mounting tray 235 and primary optical assembly 230 on LED tray 210 may be used so that a primary optical assembly 230 physically contacts an LED 220.

Each assembly tray 235 includes an opening (not shown) that allows each primary optical assembly 230 to physically contact a corresponding LED 220. In other words, each assembly tray 235 allows a primary optical assembly 230 to directly contact an LED 220 and therefore allow light from the LED 220 to pass into and be refracted by the primary optical assembly 230, as described below.

Primary optical assemblies 230 include a material that refracts or collimates light emitted by LEDs 220. For example, primary optical assemblies 230 may include an extruded refractory material. An exemplary material for primary optical assemblies 230 may be an acrylic material. For example, primary optical assemblies 230 can be formed of cast acrylic or extruded acrylic. In addition, primary optical assemblies 230 may be formed of cast acrylic with diamond polishing. Acrylic materials are suitable for optical assemblies 230 due to their excellent light transmission and UV light stability properties. For example, acrylic materials may have light transmission efficiencies on the order of 75 to 83%. An example of a suitable refractory material for the optical assemblies 230 is Acylite S10 or polymethyl methacrylate, produced by Cryo Industries.

Each of primary optical assemblies 230 may refract or collimate light transmitted by a corresponding LED 220 towards secondary optical assembly 140 (shown in FIG. 1). For example, each of primary optical assemblies 230 may refract light transmitted by an LED 220 away from tray 210. The direct physical contact between primary optical assemblies 230 and LEDs 220 increases the amount of luminous flux, or light, refracted by each of primary optical assemblies 230 towards secondary optical assembly 140 (not shown in FIG. 3). Primary optical assemblies 230 may therefore increase the light-transmission efficiency of apparatus 100 by refracting approximately all light produced by an LED 220 away from tray 210 and towards secondary optical assembly 140 (not shown in FIG. 2).

In another embodiment of the present invention, primary optical assemblies 230 include a material that does not refract or collimate light emitted by LEDs 220. In other words, primary optical assemblies 230 do not refract or collimate light emitted by LEDs 220. Primary optical assemblies 230 merely permit light emitted by LEDs 220 to pass through to secondary optical assembly 140. In such an embodiment, secondary optical assembly 140 is the only assembly (of primary optical assemblies 230 and secondary optical assembly 140) that refracts or collimates light. Such an embodiment may be desired to produce an asymmetric beam spread emanating from apparatus 100, for example.

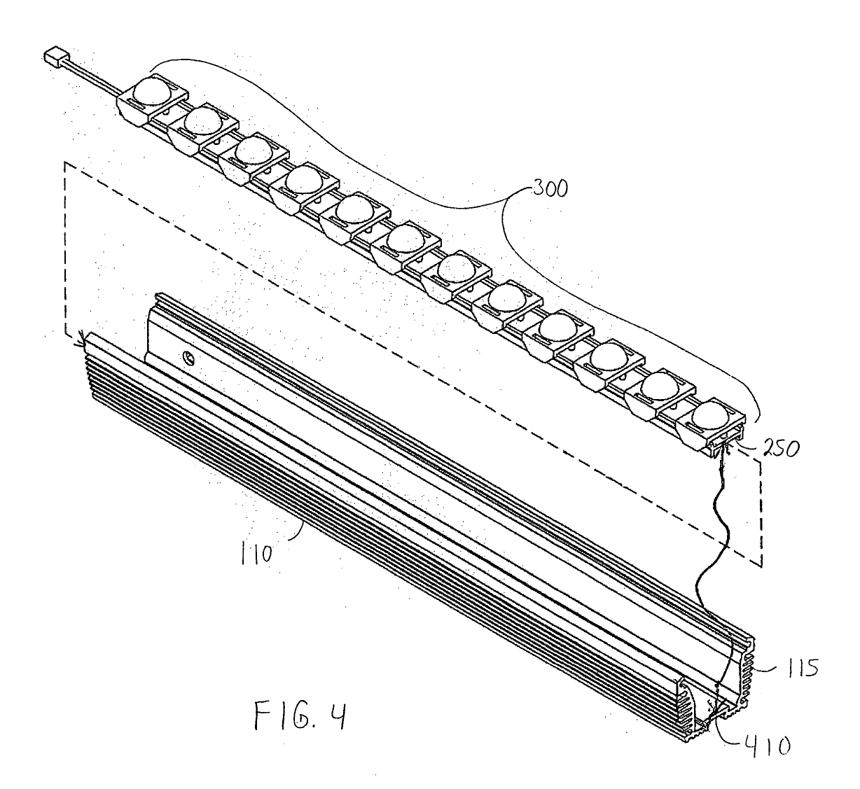

FIG. 4 illustrates a perspective view of tray assembly 300 and housing 140 prior to the insertion of tray assembly 300 in housing 140 in accordance with an embodiment of the present invention. The interior of housing 110 includes a rail 410. As described above, LED tray 210 includes a rail receptacle 250. Tray assembly 300 may then be mounted in housing 110 by sliding rail receptacle 250 of LED tray 210 over rail 410 of housing. For example, as shown by the dashed line in FIG. 4, one end of tray assembly 300 and rail receptacle 250 may be inserted over rail 410 at one end of housing 110. Tray assembly 300 may then be physically pushed along the length of housing 110 so that tray assembly 300 is located within the interior of housing 110.

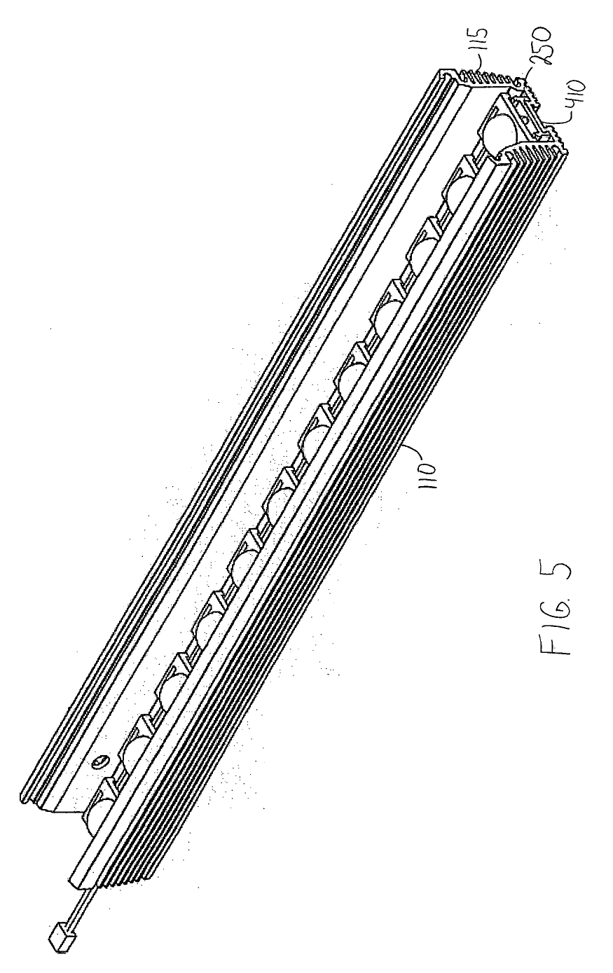

FIG. 5 illustrates a perspective view of housing 110 with tray assembly 300 inserted into the interior of housing 110 in accordance with an embodiment of the present invention. As described above, tray assembly 300 may be mounted in housing 110 using rail receptacle 250 of tray assembly 300 and rail 410 of housing 110. Tray assembly 300 may also be removed from housing 110 in a similar manner. For example, if any one or more of LEDs 220 in tray assembly 300 need to be replaced, one or more endcaps 160 (as shown in FIG. 1) may be removed from housing 110 and tray assembly 300 may be slid out of housing 110. Once tray assembly 300 has been removed from housing 110, any of the LEDs 220 may then be replaced or repaired.

Apparatus 100 therefore provides a very simple and fast mechanism by which LEDs 220 may be replaced or repaired. As LEDs 220 are not attached to primary optical assemblies 230 or assembly trays 235 (as described above), in order to replace or repair an LED 220, assembly 300 may be easily slid out of housing 110. Primary optical assembly tray 235 (and therefore primary optical assembly 230) may be similarly slid off of LED 220 or otherwise removed from LED tray 210. Doing so will expose the LED 220 so that the LED 220 may be replaced or repaired, for example.

While a rail assembly is described for mounting tray assembly 300 in housing 110, a person of ordinary skill in the art will recognize that other assemblies may be employed to mount tray assembly 300 in housing 110.

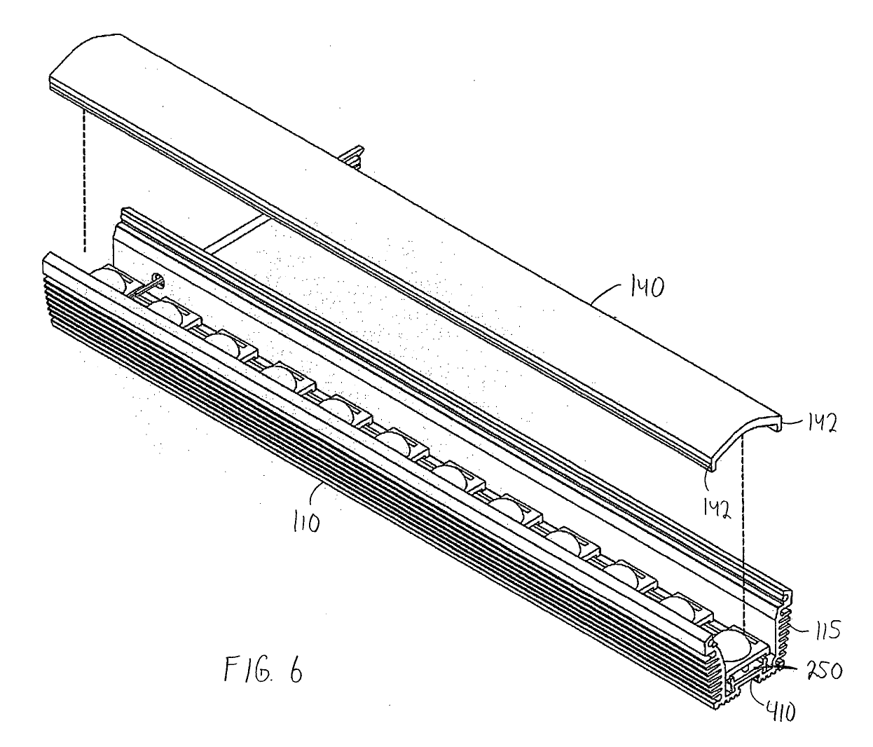

FIG. 6 illustrates a perspective view of housing 110 with secondary optical assembly 140 prior to attaching secondary optical assembly 140 to housing 110 in accordance with an embodiment of the present invention. Secondary optical assembly 140 includes two outer tabs 142 that extend along a length of assembly 140.

Secondary optical assembly 140 includes a material that refracts or collimates light. For example, secondary optical assembly 140 may include an extruded refractory material. An exemplary material for secondary optical assembly 140 may be an acrylic material. For example, secondary optical assembly 140 can be formed of cast acrylic or extruded acrylic. In addition, secondary optical assembly 140 may be formed of cast acrylic with diamond polishing. Acrylic materials are suitable for secondary optical assembly 140 due to their excellent light transmission and UV light stability properties. For example, acrylic materials may have light transmission efficiencies on the order of 75 to 83%. An example of a suitable refractory material for the secondary optical assembly 140 is Acylite S10 or polymethyl methacrylate, produced by Cryo Industries.

In another embodiment of the present invention, secondary optical assembly 140 includes a material that does not refract or collimate light. In other words, secondary optical assembly 140 does not refract or collimate light. Secondary optical assembly 140 may merely permit light to emanate from apparatus 100 along a longitudinal axis of apparatus in a beam spread along a perpendicular axis of apparatus 100. In such an embodiment, primary optical assemblies 230 are the only assemblies (of primary optical assemblies 230 and secondary optical assembly 140) that refract or collimate light. Such an embodiment may be desired to produce an asymmetric beam spread emanating from apparatus 100, for example.

FIG. 6 illustrates one method in which secondary optical assembly 140 may be attached to housing 110. Secondary optical assembly 140 may be attached to housing 110 in a number of ways. For example, an adhesive strip or bonding material may be applied to one or more of tabs 142 and corresponding edges of housing 110. Secondary optical assembly 140 can then be attached to housing 110 as shown in FIG. 6.

Secondary optical assembly 140 may also be connected to housing 110 through a “snap-fit” connection between tabs 142 of secondary optical assembly 140. A “snap-fit” connection may occur by physically compressing tabs 142 of secondary optical assembly 140 and inserting assembly 140 into housing 110. By compressing tabs 142 towards each other, the lateral size of secondary optical assembly 140 may decrease. Once secondary optical assembly 140 is placed in housing 110 and tabs 142 are no longer compressed towards each other, assembly 140 can “snap” back towards its original shape and assembly 140 can return to its approximate original size. The elasticity of secondary optical assembly 140 can provide for tabs 142 to exert pressure towards housing 110, thereby holding assembly 140 in place.

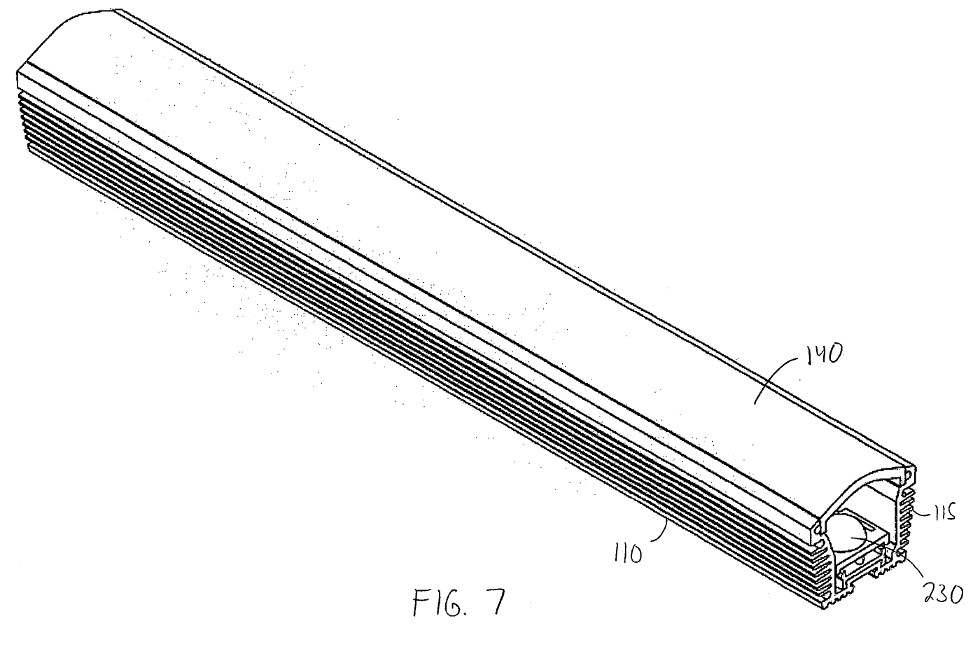

FIG. 7 illustrates a perspective view of apparatus 100 with secondary optical assembly 140 attached to housing 110 in accordance with an embodiment of the present invention. Once both primary and secondary optical assemblies 230, 140 are mounted inside and on housing, respectively, apparatus 100 can produce a continuous linear distribution of light.

In operation, primary and secondary optical assemblies 230, 140 act together to refract light emanating from a plurality of single point light sources (the LEDs 220). Once an LED 220 produces light, the light enters primary optical assembly 230. Primary optical assembly 230 harnesses the light, or luminous flux, emitted from an LED 220 and refracts the light so as to direct the light into secondary optical assembly 140. Primary optical assembly 230 may allow for total internal reflection of the light entering assembly 230, for example. As LED 220 physically contacts primary optical assembly 230, assembly 230 refracts most, if not all, of light emitted from an LED 220.

Primary optical assembly 230 refracts or collimates LED 220 light towards secondary optical assembly 140. In this way, LED 220 light that would scatter inside housing 110 if not otherwise directed is efficiently directed towards secondary optical assembly 140. For example, if primary optical assembly 230 were not placed in contact with LED 220 and between LED 220 and secondary optical assembly 140, light emitted by LED 220 may not enter and be refracted by primary optical assembly 230.

In addition, primary optical assembly 230 may also refract LED 220 light so as to produce a continuous linear beam of light directed towards secondary optical assembly 140. LEDs 220 generally produce points of light. Primary optical assembly 230 may refract points of LED 220 light so as to produce a more continuous distribution of light along at least a longitudinal axis of secondary optical assembly 140, for example.

Once primary optical assembly 230 refracts light from an LED 220, second optical assembly 140 receives the light. Second optical assembly 140 then refracts the light. Second optical assembly 140 may refract the light in any number of ways. For example, second optical assembly 140 may direct the light in a desired direction and/or in a desired distribution or beam spread.

In another embodiment of the present invention, apparatus 100 may include only one of primary optical assemblies 230 and secondary optical assembly 140. That is, only one of primary optical assemblies 230 and secondary optical assembly 140 may refract or collimate light emitted by LEDs 220. In such an embodiment, the optical assembly(ies) 140, 230 that do refract or collimate light may direct the light in a desired direction and/or in a desired distribution or beam spread, as described above. The use of a single optical assembly to refract or collimate light may be desired, for example, when producing a beam spread that is asymmetric along a perpendicular axis of apparatus 100.

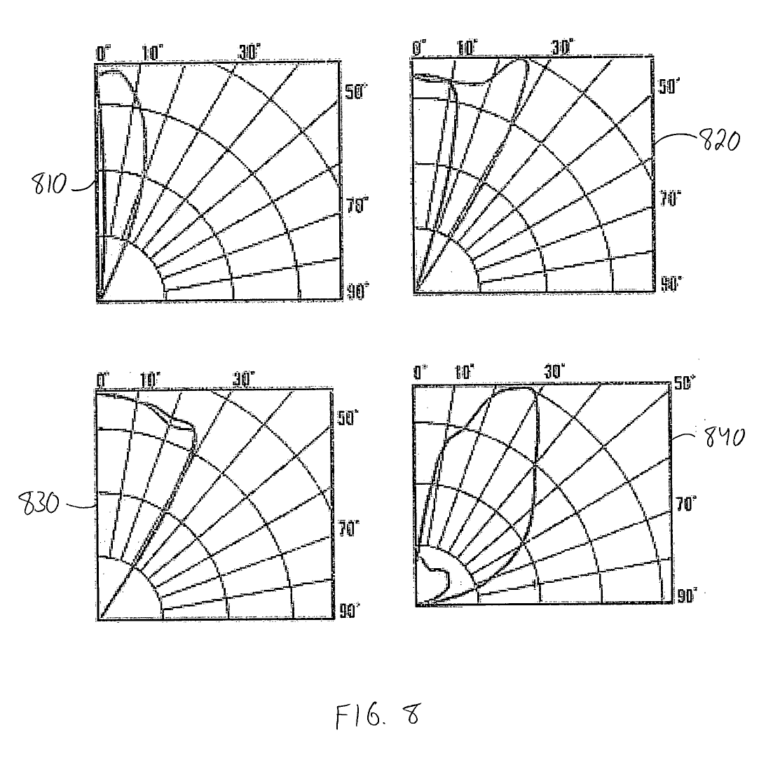

FIG. 8 illustrates several exemplary photometric graphs (810 through 840) providing average luminance at various viewing directions for apparatus 100 according to an embodiment of the present invention. Photometric graphs 810 through 830 illustrate an average luminance at varying viewing directions for apparatus 100 where primary and secondary optical assemblies 230, 140 provide a symmetric distribution of light. Primary and secondary optical assemblies 230, 140 can be configured to refract light from LEDs 220 so as to produce a narrow distribution of light (as shown, for example, by the 10° distribution in graph 810), a wide distribution of light (as shown, for example, by the 60° distribution in graph 830), or a moderate distribution of light (as shown, for example, by the 30° distribution in graph 820). In this way, based on the intrinsic refractory properties of primary and secondary optical assemblies 230, 140, apparatus 100 can provide a wide range of light distributions.

In addition, primary and secondary optical assemblies 230, 240 can be configured to refract light in an asymmetric distribution. For example, graph 840 illustrates a photometric graph of light produced by apparatus 100 in an asymmetric distribution pattern. Graph 840 may be produced, for example, by configuring primary and secondary optical assemblies 230, 140 to refract light in a non-uniform manner. In another embodiment of the present invention, either primary or secondary optical assemblies 230, 140 refract or collimate light, but not both (as described above). In other words, either primary optical assemblies 230 or secondary optical assembly 140 may be employed to produce an asymmetric beam spread.

While four photometric graphs are shown in FIG. 8 to illustrate light distribution patterns possible with apparatus 100, a number of other light distributions are possible within the scope of the present invention. Graphs 810 through 840 are intended merely as examples. Nothing in FIG. 8 should be construed as a limitation on the present invention.

One or more of primary and secondary optical assemblies 230, 140 may also provide for inter-reflectance of light emitted by LEDs 220. For example, LEDs 220 may include a plurality of LEDs 220 that produce light of the same or similar color. However, some LEDs 220 may produce brighter light or light of a slightly different shade than other LEDs 220. Primary and secondary optical assemblies 230, 240 can refract light from all of the LEDs 220 so as mix the light and produce a more even and continuous distribution of light from apparatus 100 than would otherwise be available.

Similarly, LEDs 220 may include a plurality of LEDs 220 that produce different colored light. Primary and secondary optical assemblies 230, 240 can be configured to refract light from all of the LEDs 220 so as mix the different colored light. By mixing the light, apparatus 100 can be configured to produce a wide range of light colors.

The combination of primary and secondary optical assemblies 230, 140 provide for a very efficient linear lighting apparatus 100. As described above, primary optical assembly 230 harnesses light emitted by LEDs 220 so that the amount of light entering second optical assembly 140 is increased over linear lighting assemblies currently available. Secondary optical assembly 140 may then be used to direct, diffuse or refract light in any one of a number of customizable and desired ways. In this way, primary and secondary optical assemblies 230, 140 act in series to refract light from LEDs 220 so as to produce a continuous linear light beam from apparatus 100. A continuous linear light beam includes a light beam that is produced by light uniformly emanating along the longitudinal length of apparatus 100.

In addition to the benefit of increased lighting efficiency, apparatus 100 can also provide for increased heat dissipation of thermal energy generated by LEDs 220. Each of LEDs 220 produce considerable thermal energy, which can shorten the lifespan of an LED 220, thereby causing decreased performance and/or early failure of an LED lighting device. Therefore, the increased heat dissipation of apparatus 100 can provide for increased performance and a longer lifespan of apparatus 100.

As described above, each LED 220 is mounted on an LED tray 210. LED tray 210 can be formed of a thermally conductive material. For example, LED tray 210 can be formed of extruded aluminum. Heat generated by LEDs 220 can therefore be conducted, or passed, from LEDs 220 to LED tray 210.

In another embodiment of the present invention, LEDs 220 may be mounted on LED tray 210 using a thermally conductive adhesive material. For example, LEDs 220 may each be attached to LED tray 210 by applying a thermally adhesive tape to one or more of LEDs 220 and tray 210. The use of a thermally conductive adhesive to attach LEDs 220 can increase the dissipation of heat in apparatus 100.

Also as described above, LED tray 210 can be mounted in housing 110 by sliding rail receptacle 250 of tray 210 over rail 410 of housing 110. LED tray 210 can also be mounted in housing 110 in any manner known to those of ordinary skill in the art. The rail receptacle 250 and rail 410 combination is provided merely as an example.

Housing 110 can also be formed of a thermally conductive material. For example, housing 110 can be formed of extruded, anodized aluminum. By mounting LED tray 250 on housing 110, heat can pass from LED tray 250 to housing 110. Therefore, a combination of LED tray 210 and housing 110 can act as a heat sink for thermal energy generated by LEDs 220. For example, thermal energy generated by LEDs 220 is passed, or conducted, to LED tray 210. The thermal energy is then passed, or conducted, to housing 110. Housing 110 may then dissipate the thermal energy into the atmosphere.

In another embodiment of the present invention, LED tray 210 passes thermal energy to housing 110 through a thermally conductive material between tray 210 and housing 110. For example, a thermal adhesive may be placed between tray 210 and housing 110 to hold tray 210 in place and to increase the thermal conductivity between tray 210 and housing 110.

As described above, housing 110 can include a plurality of ribs 115. In order to increase the capacity of housing 110 (and therefore apparatus 100) to dissipate heat, the creation of ribs 115 on the exterior of housing 110 causes the total surface area of housing 110 to increase. As the surface area of housing 110 increases, the capacity of housing 110 to dissipate heat increases.

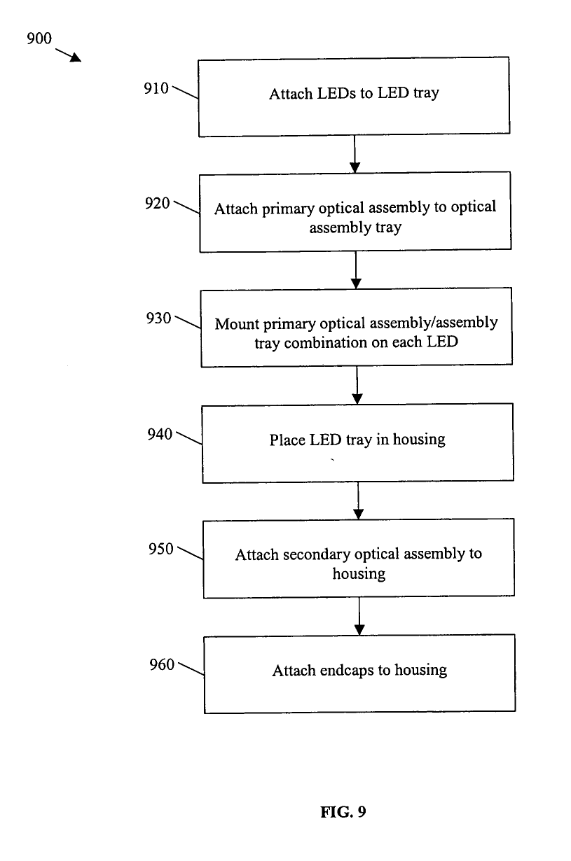

FIG. 9 illustrates a flowchart for a method 900 of configuring a linear LED lighting apparatus 100 to produce a continuous linear beam of light in accordance with an embodiment of the present invention. First, at step 910, a plurality of LEDs 220 is attached to an LED tray 210, as described above.

Next, at step 920, a plurality of primary optical assemblies 230 are attached to a plurality of optical assembly trays 235, as described above.

Next, at step 930, the plurality of primary optical assembly 230/assembly tray 235 combinations is mounted on the plurality of LEDs 220. As described above, each assembly/tray combination is mounted on an LED 220. Each optical assembly tray 235 is configured so as to allow physical contact between a primary optical assembly 230 and an LED 220.

Next, at step 940, LED tray 210 (with a plurality of optical assembly 230/assembly tray 235 combinations) is placed in a housing 110. As described above, LED tray 210 may be placed in housing 110 using a rail or other type of mechanism.

Next, at step 950, a secondary optical assembly 140 is attached to housing 110. As described above, secondary optical assembly 140 can be attached to housing 110 through a “snap-fit” connection or some type of bonding adhesive, for example.

Next, at step 960, one or more endcaps 160 are attached to one or more ends of housing 110. Endcaps 160 may prevent light emitted by LEDs 220 from escaping one or more ends of apparatus 100. At the completion of step 960, a linear LED lighting apparatus 100 is configured to produce a continuous linear beam of light.

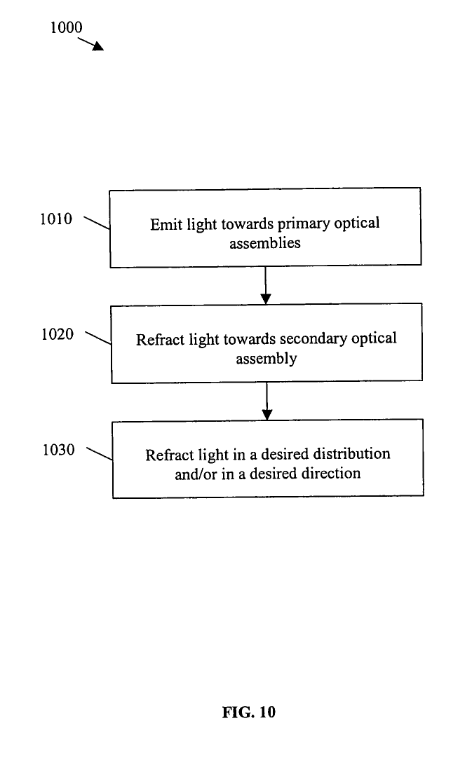

FIG. 10 illustrates a flowchart for a method 1000 of producing a continuous linear beam of light from a plurality of point sources of light in accordance with an embodiment of the present invention. First, at step 1010, a plurality of point sources of light 220 produce light towards a plurality of primary optical assemblies 230. For example, a plurality of LEDs 220 can emit light towards a plurality of primary optical assemblies 230.

Next, at step 1020, the light is refracted in the primary optical assemblies 230. Primary optical assemblies 230 refract the light towards a secondary optical assembly 140, as described above. As primary optical assemblies 230 may be in physical contact with the point sources of light 220, primary optical assemblies 230 may serve to refract approximately all light emitted by the point sources of light 220, for example.

Next, at step 1030, the secondary optical assembly 140 refracts the light. As described above, secondary optical assembly 140 can refract the light in a desired distribution and/or desired direction. The combination of refraction in primary and secondary optical assemblies 230, 140 can produce a continuous linear beam of light from a plurality of point sources of light.

In another embodiment of the present invention, either primary optical assemblies 230 or secondary optical assembly 140 refract or collimate light, but not both. In other words, method 1000 includes either step 1020 or 1030, but not both. In such an embodiment, the optical assembly(ies) 140, 230 that do collimate or refract light act to produce a continuous linear beam of light from a plurality of point sources of light.

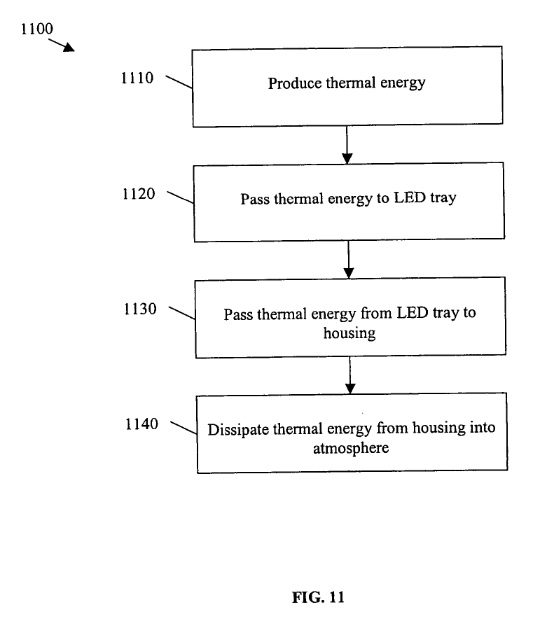

FIG. 11 illustrates a flowchart for a method 1100 of improving the dissipation of heat generated by a plurality of LEDs 220 in a linear lighting apparatus 100 in accordance with an embodiment of the present invention. First, at step 1110, a plurality of LEDs 220 produces thermal energy as each LED 220 produces light in a linear lighting apparatus 100.

Next, at step 1120, the thermal energy is passed, or conducted, from the plurality of LEDs 220 to an LED tray 210, as described above. The thermal energy may be passed from LEDs 220 to tray 210 through direct physical contact or through an intermediary, such as a thermally conductive adhesive material between LEDs 220 and tray 210.

Next, at step 1130, the thermal energy is passed, or conducted, from the LED tray 210 to a housing 110 of the lighting apparatus 100. The thermal energy may be passed through a physical contact between tray 210 and housing 110. The thermal energy may be passed from tray 210 to housing 110 through direct physical contact or through an intermediary, such as a thermally conductive adhesive material between tray 210 and housing 110.

Next, at step 1140, the thermal energy is dissipated through the surface area of housing 110. As described above, housing 110 may include ribs 115 to increase the surface area of housing 110. An increased surface area can provide for increased capacity of housing 110 to dissipate thermal energy.

Thus, the apparatus and method described above provide for a linear lighting apparatus with improved light-transmission efficiency and heat dissipation. While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features that come within the spirit and scope of the invention.

What is claimed is:

1. A linear lighting apparatus with improved heat dissipation including:
a plurality of light emitting diodes capable of emitting light;
a plurality of primary optical assemblies each in contact with one of said plurality of light emitting diodes, said primary optical assemblies configured to refract said light towards a secondary optical assembly, said secondary optical assembly configured to refract said light so as to cause light to emanate from said apparatus; and
an apparatus housing holding said secondary optical assembly and configured to dissipate radiated energy from said light emitting diodes.

2. The apparatus of claim 1, wherein said plurality of primary optical assemblies and said secondary optical assembly each comprise an extruded acrylic material.

3. The apparatus of claim 1, wherein said primary optical assemblies are configured to collimate said light.

4. The apparatus of claim 1, further including a light emitting diode tray configured to transfer thermal energy from said light emitting diodes to said apparatus housing.

5. The apparatus of claim 4, wherein said light emitting diodes are mounted on said tray.

6. The apparatus of claim 5, wherein said tray is capable of being removed from said housing for repair and/or replacement of one or more of said light emitting diodes.

7. The apparatus of claim 1, wherein said light emitting diodes are point sources of said light and each of said plurality of primary optical assemblies and said secondary optical assembly are configured to refract said light so as to provide a light beam continuous along a longitudinal length of said apparatus.

8. The apparatus of claim 1, wherein said secondary optical assembly is held by a snap-fit connection between a pair of tabs of said secondary optical assembly and a pair of recesses in said housing.

9. A method for improving the heat dissipation in a linear lighting apparatus, said method including:
emitting light from a plurality of light emitting diodes;
contacting a plurality of primary optical assemblies with said light emitting diodes;
refracting said light in each of said primary optical assemblies towards a secondary optical assembly;
refracting said light in a secondary optical assembly so that said light is directed in at least one of a desired direction and a desired distribution as said light emanates from said apparatus; and
dissipating thermal energy generated by said light emitting diodes through a housing of said apparatus.

10. The method of claim 9, wherein said plurality of primary optical assemblies and said secondary optical assembly each comprise an extruded acrylic material.

11. The method of claim 9, wherein said refracting step includes said primary optical assemblies collimating said light.

12. The method of claim 9, wherein said dissipating step includes transferring said thermal energy from said light emitting diodes to a tray holding said light emitting diodes to said apparatus housing.

13. The method of claim 12, wherein said step of refracting said light in said secondary optical assembly includes refracting said light in an asymmetric distribution.

14. The method of claim 9, wherein said steps of refracting said light in each of said primary optical assemblies and refracting said light in said secondary optical assembly produces a linear light beam continuous along a length of said linear lighting apparatus.

15. The method of claim 9, further including holding said secondary optical assembly in a housing of said apparatus by a snap-fit connection between a pair of tabs of said secondary optical assembly and a pair of recesses in said housing.

16. A lighting apparatus with increased heat dissipation capabilities, said apparatus including:
a thermally conductive housing of said apparatus;
a thermally conductive tray mounted in said housing; and
a plurality of light sources attached to said tray, said light sources producing thermal energy that is transferred from said light sources to said tray and from said tray to said housing.

17. The lighting apparatus of claim 16, wherein at least one of said housing and said tray includes extruded aluminum.

18. The lighting apparatus of claim 16, wherein said plurality of light sources includes a plurality of light emitting diodes.

19. The lighting apparatus of claim 16, wherein said housing includes a plurality of ribs on an exterior of said apparatus.

20. The lighting apparatus of claim 16, further including a plurality of refractory optical assemblies refracting light emitted by said plurality of light sources in at least one of a desired direction and a desired distribution.
